(19) United States
(12) Patent Application Publication
(10) Pub. No.: US 2025/0238948 A1
(43) Pub. Date: Jul. 24, 2025

(54) Learned Stereo Synthetic Data

(71) Applicant: Toyota Research Institute, Inc., Los Altos, CA (US)

(72) Inventors: Mark Tjersland, Mountain View, CA (US); Max Bajracharya, Mibrae, CA (US)

(73) Assignees: Toyota Research Institute, Inc., Los Altos, CA (US); Toyota Jidosha Kabushiki Kaisha, Toyota-shi (JP)

(21) Appl. No.: 18/417,431

(22) Filed: Jan. 19, 2024

(51) Int. Cl. G06T 7/593

(52) U.S. Cl. CPC G06T 7/596; G06T 2207/10012; G06T 2207/20081; G06T 2207/20084

(57) ABSTRACT

A method for training a learned stereo architecture includes receiving, from a graphic rendering system, a plurality of stereo image pairs comprising a variety of disparate scenes and scene parameters, where: a first subset of stereo image pairs correspond to a first baseline, and a second subset of stereo image pairs correspond to a second baseline different from the first baseline; inputting the plurality of stereo image pairs into a stereo architecture comprising one or more 3D convolution networks configured to learn disparity estimation based on the plurality of stereo image pairs; comparing disparity estimations from the stereo architecture with ground truth disparity from the graphic rendering system to generate training feedback; and adjusting one or more neural network models implemented by the stereo architecture based on the training feedback thereby configuring the learned stereo architecture.

### TECHNICAL FIELD

The present disclosure relates to a learned stereo architecture, methods of training of the learned stereo architecture that expand the flexibility of the learned stereo architecture.

### BACKGROUND

Stereo depth estimation continues to attract research and development activity. Stereo depth estimation systems and methods utilize image based sensors to collect image, optionally including video data, of an environment which are then processed by stereo depth estimation systems to generate a depth field of the environment. A desire to advance the stereo depth estimation is that such systems do not require other depth sensors such as LiDAR, radar, sonar, or the like. Stereo depth estimation systems and methods can utilize image based sensors which are versatile for other operations such as object detection, navigation, motion detection, and the like. Accordingly, systems such as autonomous vehicles, robots, and the like do not need additional sensor packages for operation.

Research and development of stereo depth estimation includes but is not limited to seeking advancements in depth sensing from image data, improvements in accuracy and refinement of depth values and depth fields, and among others, improvements in computational resources and speed of computation.

### SUMMARY

In one embodiment, a method for training a learned stereo architecture comprises receiving, from a graphic rendering system, a plurality of stereo image pairs comprising a variety of disparate scenes and scene parameters, wherein: a first subset of stereo image pairs correspond to a first baseline, and a second subset of stereo image pairs correspond to a second baseline different from the first baseline; inputting the plurality of stereo image pairs into a stereo architecture comprising one or more 3D convolution networks configured to learn disparity estimation based on the plurality of stereo image pairs; comparing disparity estimations from the stereo architecture with ground truth disparity from the graphic rendering system to generate training feedback; and adjusting one or more neural network models implemented by the stereo architecture based on the training feedback thereby configuring the learned stereo architecture.

In another embodiment, an apparatus for training a learned stereo architecture, comprising: one or more memories comprising processor-executable instructions; and one or more processors configured to execute the processor-executable instructions and cause the apparatus to: receive, from a graphic rendering system, a plurality of stereo image pairs comprising a variety of disparate scenes and scene parameters, wherein: a first subset of stereo image pairs correspond to a first baseline, and a second subset of stereo image pairs correspond to a second baseline different from the first baseline; input the plurality of stereo image pairs into a stereo architecture comprising one or more 3D convolution networks configured to learn disparity estimation based on the plurality of stereo image pairs; compare disparity estimations from the stereo architecture with ground truth disparity from the graphic rendering system to generate training feedback; and adjust one or more neural network models implemented by the stereo architecture based on the training feedback thereby configuring the learned stereo architecture.

In another embodiment, a non-transitory computer-readable medium comprising processor-executable instructions that, when executed by one or more processors of an apparatus, causes the apparatus to perform a method comprising: receiving, from a graphic rendering system, a plurality of stereo image pairs comprising a variety of disparate scenes and scene parameters, wherein: a first subset of stereo image pairs correspond to a first baseline, and a second subset of stereo image pairs correspond to a second baseline different from the first baseline; inputting the plurality of stereo image pairs into a stereo architecture comprising one or more 3D convolution networks configured to learn disparity estimation based on the plurality of stereo image pairs; comparing disparity estimations from the stereo architecture with ground truth disparity from the graphic rendering system to generate training feedback; and adjusting one or more neural network models implemented by the stereo architecture based on the training feedback thereby configuring a learned stereo architecture.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and are not intended to limit the disclosure. The following detailed description of the illustrative embodiments can be understood when read in conjunction with the following drawings, where like structure is indicated with like reference numerals.

FIG. 1 schematically depicts an illustrative block diagram of a learned stereo architecture, according to one or more embodiments shown and described herein;

FIG. 2 depicts an illustrative visualization of image data input to feature extractors of the learned stereo architecture and corresponding feature images generated by the feature extractors of the learned stereo architecture depicted in FIG. 1, according to one or more embodiments shown and described herein;

FIG. 3 depicts an illustrative visualization of the feature images input to the cost volume block of the learned stereo architecture and an illustrative visualization of a low resolution disparity estimate generated by the disparity regression block of the learned stereo architecture depicted in FIG. 1, according to one or more embodiments shown and described herein;

FIG. 4 depicts an illustrative visualization of inputs and output of the learned upsampling block of the learned stereo architecture depicted in FIG. 1, according to one or more embodiments shown and described herein;

FIG. 5 depicts an example learned upsampling process performed by the learned upsampling block of the learned stereo architecture depicted in FIG. 1, according to one or more embodiments shown and described herein;

FIG. 6A depicts an illustrative visualization of inputs and outputs of the refinement block and addition block of the learned stereo architecture depicted in FIG. 1, according to one or more embodiments shown and described herein;

FIG. 6B depicts an illustrative visualization of the improvement to the disparity estimate generated by the refinement block of the learned stereo architecture depicted in FIG. 1, according to one or more embodiments shown and described herein;

FIG. 7 schematically depicts an illustrative block diagram of a process for training the learned stereo architecture depicted in FIG. 1, according to one or more embodiments shown and described herein;

FIG. 8 depicts an illustrative method for training a learned stereo architecture, according to one or more embodiments shown and described herein; and

FIG. 9 depicts an example apparatus for training the learned stereo architecture, according to one or more embodiments shown and described herein.

### DETAILED DESCRIPTION

Embodiments of the present disclosure are directed to a learned stereo architecture configured to ingest stereo image data and generate a refined disparity dataset that can be used for depth estimation. The learned stereo architecture described herein provides several technical advantages over prior stereo depth estimation systems and methods. The learned stereo architecture leverages fully differentiable 3D convolutions instead of a mix of 2D and 3D convolution stages. By leveraging fully differentiable 3D convolutions, the learned stereo architecture provides a technical benefit of flexibility.

Flexibility refers to the ability for a learned stereo architecture to be implemented across a wide range of stereo camera system (e.g., various hardware implementations). Flexibility of a learned stereo architecture further enables capabilities such as online dynamic adjustments to parameters such as resolution and range. For example, a user or system, such as robot manipulation system or a vehicle navigation and/or collision avoidance system, post training (e.g., online implementation of the learned stereo architecture), can specify to the learned stereo architecture a desired range and resolution for refined disparity data and/or depth estimation. In the example of vehicle navigation, a vehicle navigation system may need or rely more heavily on disparity data corresponding to distances that are close when the vehicle is operating in a city for example as opposed to distances that are far when the vehicle is operating in a rural environment or along an interstate. As such, the vehicle navigation system, implementing the same flexible, learned stereo architecture for both contexts request the desired range for its current situation.

Accordingly, the technical benefit of providing a flexible, learned stereo architecture reduces the need for storing and configuring multiple baseline specific architectures, reduces the time and cost of training and updating multiple baseline specific architectures, and provides the ability to dynamically select range and resolution specific information that a secondary system such as robot manipulation or vehicle navigation system may require. To deliver the aforementioned technical benefits, technical solutions for maintaining or reducing processing speed and computational demands for the flexible, learned stereo architecture are needed. Additionally, technical solutions for efficiently and effectively training the flexible, learned stereo architecture are needed. As described in more detail herein, the learned stereo architecture leverages fully differentiable 3D convolutions instead of a mix of 2D and 3D convolution stages and is trained with fully synthetic labeled data instead of real image data.

Fully synthetic labeled data provides an exponential increase in the amount and quality of diverse datasets that are also finely labeled at the pixel level since they are generated from graphic rendering systems that can deliver realistic synthetic image data not previously attainable. The fully synthetic labeled data additionally enables training data to include, for example, stereo image pairs that correspond to various baselines, scene parameters (e.g., lighting levels, surfaces, materials, textures, and the like), resolutions, and the like. The fully synthetic labeled data is more than 3 channel data (e.g., red, green, blue data). The fully synthetic labeled data may be more than 3 channel data, for example 16 or 32 channel, where each of the additional channels provide the learned stereo architecture with additional information for training so that when RGB images are fed into the model in an online implementation the learned stereo architecture has developed a diverse set of neural paths and is thus capable of inferences that would not be available from training using sparely pixel labeled RGB real world image pairs.

As mentioned here before, prior stereo depth estimation systems and methods are limited to a predefined baseline, field of view, and range. Baseline refers to the image sensor configuration such as the structural mounting relationship between the two cameras mounted in the stereo system. For example, parameters defining the baseline may include, camera pose, the distance between the cameras, the respective orientation angle, and even camera intrinsic parameters such as focal length, scale factor, geometric distortion, and the like. Field of view refers to the observable area of the stereo camera system. Range refers to how far a camera or stereo camera system can see. The range depends on the focal length of the cameras. Prior stereo depth estimation systems are designed, an in the case of a learned stereo depth estimation model, trained to function within a predefined baseline. That is, they are tuned to provide accurate disparity and/or depth estimations for image pairs that conform to the generally limited and predefined baseline. Baselines are generally designed for particular stereo camera hardware. Furthermore, the flexibility of prior learned stereo depth estimation systems are encumbered by the time and cost of training a learned stereo depth estimation model is expensive. The baseline that prior learned stereo depth estimation systems are capable of operating within are mainly driven from the cost and time of collecting real image data and accurately labeling most but likely not all of the pixels in each of the images used for training.

The following will now describe aspects of the learned stereo architecture in more detail with reference to the drawings and where like numbers refer to like structures. First, aspects of the models implemented to forms the learned stereo architecture are described. Second, aspects relating to training the learned stereo architecture are described. Third, aspects relating to the flexibility and online operation of the learned stereo architecture are described.

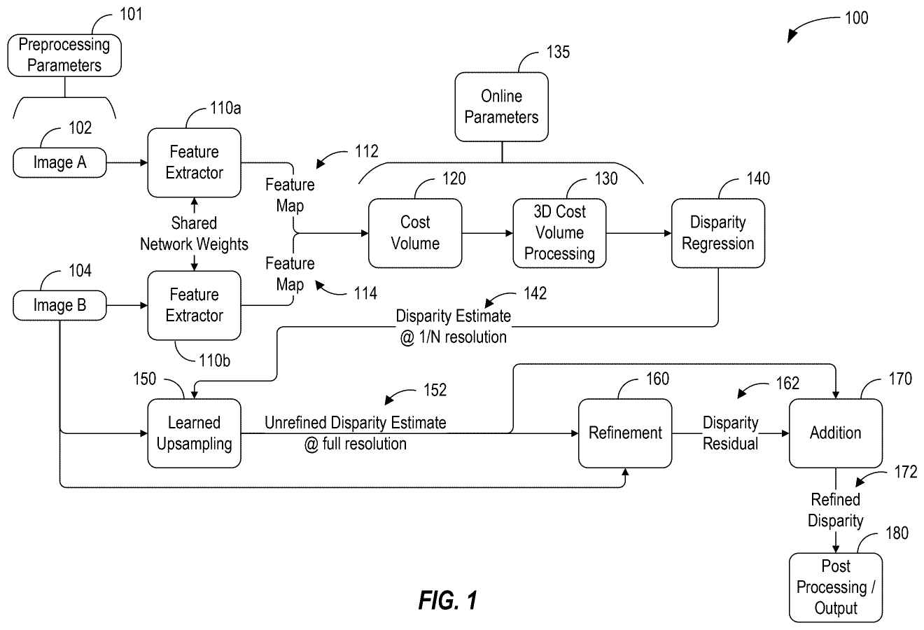

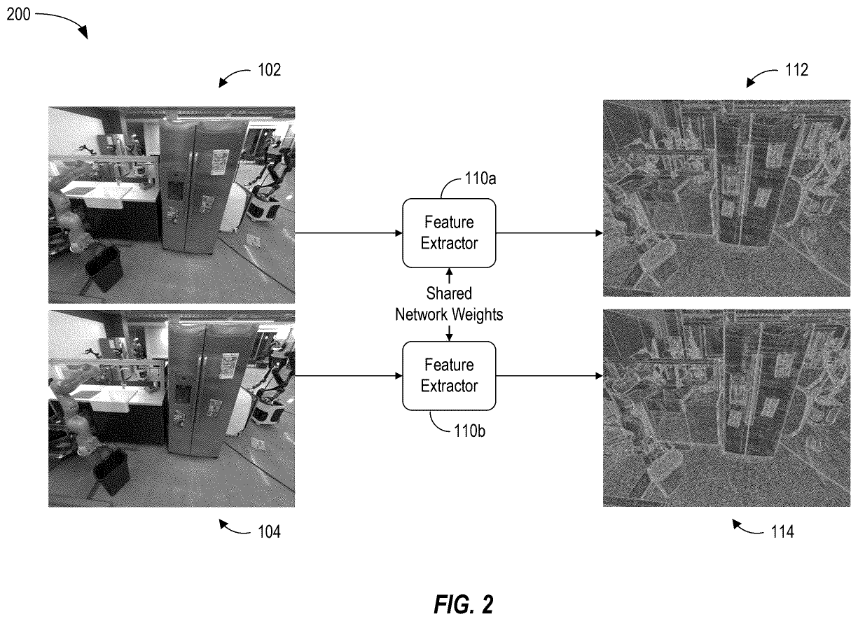

Aspects of the models implemented to forms the learned stereo architecture are now described with reference to FIGS. 1-6B. FIG. 1 depicts an illustrative block diagram of a learned stereo architecture 100. Reference will be made to FIGS. 2-6B to support discussion of particular blocks depicted in the learned stereo architecture 100 of FIG. 1 and more specifically illustrative visualizations of the inputs, data, and outputs throughout implementation of the learned stereo architecture 100.

The learned stereo architecture 100 is configured to receive a stereo image pair, image A 102 and image B 104 as an input. Image A 102 may be a right stereo image and image B 104 may be a left stereo image or vice versa. The stereo image pair may be generated from one or a variety of stereo image systems. For example, stereo image systems include Microsoft Azure Kinect sensor, Intel Realsense D415 array, Basler stereo cameras, or the like. Each of these commercially available systems may include different baselines. That is, the camera position, field of view, camera pose, camera intrinsic, and the like may differ between each system. Accordingly, previously learned stereo systems would need be trained and tailored to receive image data for a stereo camera system having a baseline that corresponds to that of the training data used for training the learned stereo system. However, as described herein, the learned stereo architecture 100 is designed and trained to be flexible such that a plurality of different stereo image systems can be used to collect the stereo image pairs. In other words, having a flexible, learned stereo architecture enables a robot or vehicle engineer, for example, the ability to select one of a variety of stereo image systems for implementation without the need for expending time and costs for training a stereo depth estimation model to work with the selected stereo image system.

In some embodiments, the preprocessing step 101 may be configurable by a user or system interfacing with the learned stereo architecture 100. For example, if a particular response speed of the learned stereo architecture 100 is desired, the preprocessing step 101 may receive a resolution parameter that is used to resize the input images (e.g., image A 102 and image B 104) fed into the learned stereo architecture 100. In this way, a user or other system such as a robot or vehicle system, for example, can achieve a desired response speed from the learned stereo architecture 100.

The learned stereo architecture 100 includes a pair of feature extractors 110a, 110b configured to share network weights, a cost volume block 120, a 3D cost volume processing block 130, a disparity regression block 140, a learned upsampling block 150, a refinement block 160, an addition block 170 and a post processing/output block 180. Each of the aforementioned aspects of the learned stereo architecture 100 will now be discussed in detail.

The pair of feature extractors 110a, 110b are discussed with reference to FIGS. 1 and 2. FIG. 2 depicts an illustrative visualization of image data input, image A 102 and image B 104, to the pair of feature extractors 110a, 110b of the learned stereo architecture 100 and corresponding feature maps, feature map 112 and feature map 114, generated by the feature extractors of the learned stereo architecture 100 depicted in FIG. 1.

The pair of feature extractors 110a, 110b may be residual neural networks (ResNet). ResNet is a deep learning model used for computer vision applications. The pair of feature extractors 110a, 110b are trained to output a feature map (e.g., feature map 112 and feature map 114) for each image in the stereo image pair (image A 102 and image B 104). The feature map is downsampled by the pair of feature extractors 110a, 110b from the input resolution by a predefined factor. The predefined factor may be a first value for a first resolution value of the input image and may be a second value for a second resolution value of the input image. For example, for a high resolution image (e.g., a first resolution value), the predefined factor (e.g., the first value) may be greater than the predefined factor (e.g., the second value) for a low resolution image (e.g., the second resolution value). For example, the predefined factor may be a value (N) of 2, 4, 8, or more.

An illustrative example of image A 102 and image B 104 is depicted in FIG. 2. The feature extractors 110a and 110b, as discussed above, generate a feature map 112 and 114 for each image A 102 and image B 104, respectively. Since the feature maps 112 and 114 are multi-dimensional, to visualize the multiple dimensions various colors may be assigned to pixels values. Each feature map, for example, feature map 112 and feature map 114, may be a multi-dimensional feature map, for example, but without limitation, a 16-dimensional feature map. FIG. 2 is merely provided for illustrative purposes, as the feature maps 112 and 114 are not necessarily datasets that can be easily visualized in color, but rather can be represented as multi-dimensional matrices, for example.

The pair of feature extractors 110a, 110b may be a convolutional neural network (CNN) architecture designed to support hundreds or thousands of convolutional layers. The weights of each of the feature extractors are shared which enables each network to learn the same pattern regardless of its position in the input.

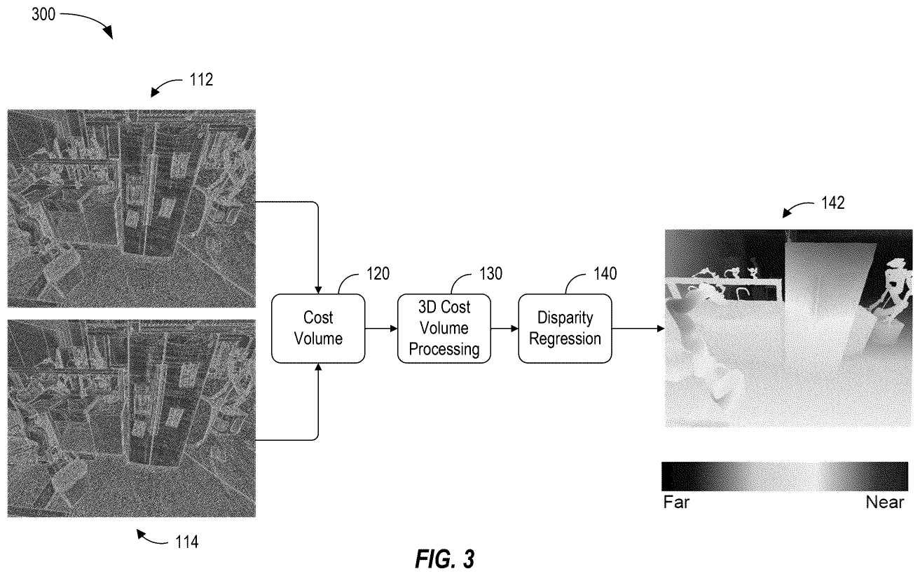

The cost volume stage of the learned stereo architecture 100 includes the cost volume block 120, the 3D cost volume processing block 130, and the disparity regression block 140, which are discussed with reference to FIGS. 1 and 3. FIG. 3 depicts an illustrative visualization of the feature maps 112 and 114 generated by the pair of feature extractor 110a and 110b and input to the cost volume block 120 of the learned stereo architecture 100. FIG. 3 further depicts an illustrative visualization of a low resolution disparity estimate generated by the disparity regression block 140 of the learned stereo architecture 100 depicted in FIG. 1.

The cost volume block 120 receives the feature maps 112 and 114 generated by the pair of feature extractor 110a and 110b and generates a cost volume for input to the 3D cost volume processing block 130. The cost volume block 120 may include a cross-correlation cost volume used to create a 4D feature volume at a configurable number of disparities. The cost volume that is generated by shifting image A 102 with respect to image B 104, at first without any transformations. For example, image A 102 is considered the shifted image and image B 104 is the reference image. The cost volume structure comprises values for height and width of the image and depth values per pixel based on the number of shifts of the images that are needed to align pixels corresponding to the same points in the environment.

Here, the features in image A 102 and image B 104 (e.g., left and right images) are shifted relative to each other to determine how well they match. For example, a short shift indicates that the features are far from the camera and a long shift indicates that the features are close by. In binocular stereo systems, a preprocessing step of rectification may be implemented to the input images (e.g., image A 102 and image B 104), so that the same points in space will be found along the same horizontal row of pixels. In this way, shifting may be limited to horizontal shifts in step sizes of a predefined number of pixels per shift. Shifting is repeated for a predefined number of iterations or until a percentage of pixels in image A 102 are found to match a corresponding pixel in image B 104.

In some embodiments, a user or other system such as a robot or vehicle system may provide online parameters 135 to the cost volume block 120 and/or the 3D cost volume processing block 130 that control the shifting operations. For example, the online parameters 135 may define predefined number of shifts and/or shift step sizes. The predefined number of shifting iterations and the shifting step size may be defined by the user or a connected system as discussed above based on a desired range (e.g., depth range of interest, such as close field depths, middle field depths, or far field depths). Since the learned stereo architecture 100 is trained across a range of baselines and comprehensively at near and far field depth estimates, in some embodiments, the learned stereo architecture 100 can be parameterized in an online environment to deliver depth information for features located at particular depth ranges.

The 3D cost volume processing block 130 receives the cost volume generated by the cost volume block 120. The 3D cost volume processing block 130 implements one or more 3D convolution networks where the kernel slides are 3 dimensional as opposed to 2 dimensional with 2D convolutions. Implementing one or more 3D convolution networks, instead of 2D convolutions or a mix of 3D and 2D convolutions as done by other, less flexible, stereo estimation systems, enables the learned stereo architecture 100 to learn and retain patterns with respect to width, height, and depth during training from the fully synthetic labeled data as opposed to just height and width in 2D convolution implementations. The fully synthetic labeled data used for training as compared to labeled real image data includes vastly more label information, for example, label (e.g., semantic) information per pixel. Additionally, the labeled real image data is not per pixel labeled and requires significant time and cost to incorporate even sparse labeling information. The fully synthetic labeled data also enables the one or more 3D convolution networks of the learned stereo architecture 100 to learn more details (e.g., compared to a 2D convolution) from the input dataset, such as depth values per pixel. Additionally, the fully synthetic labeled data has fewer artifacts (noise) as compared to real image data. The 3D cost volume processing block 130 generates 3D volume structures where the depth values per pixel are corrected based on learning obtained from the fully synthetic labeled data. For example, when there is not a good correlation between left and right images, for example, when one of the image sensor is occluded from viewing a feature in an environment that the other image sensor can capture in an image, the one or more 3D convolution networks can provide an estimation as to the correctness of a depth value for the occluded pixel(s).

The 3D volume structure generated by the 3D cost volume processing block 130 comprises a height, width, and depth representation of the environment captured by the pair of stereo images. The disparity regression block 140 then receives the 3D volume structure and collapses it down into a disparity estimate. The disparity estimate is an image of height by width where each pixel is a disparity value. The disparity regression block 140 includes an operation to find the area where the matching cost is minimized to represent the best disparity value. Given an x-y pixel, a 1D chart is generated where either a peak or trough is present at the correct value depending on whether the applied function is a max or min cost function, respectively. For example, for a given pixel there will be a graph of cost along the x-axis which is used to determine what is the best cost for each pixel as part of the disparity regression operation at the disparity regression block 140.

The cost corresponds to a disparity value which represents how many pixels between the input images (e.g., image A 102 and image B 104) would give the most accurate depth estimate. However, at this stage the disparity value is not a depth metric, but rather a disparity metric referring to the number of pixel shifts.

As depicted in FIG. 3, for example, an illustrative low resolution disparity estimate 142 is depicted. The low resolution disparity estimate 142 may be ½, ¼, ⅛ or another reduce resolution (1/N) value compared to the full resolution of the input images (e.g., image A 102 and image B 104). Accordingly, once the low resolution disparity estimate 142 is converted to a resolution that corresponds to the full resolution of the input images (e.g., image A 102 and image B 104) the disparity values can be converted to depth values based on properties of the image sensors that captured the input images.

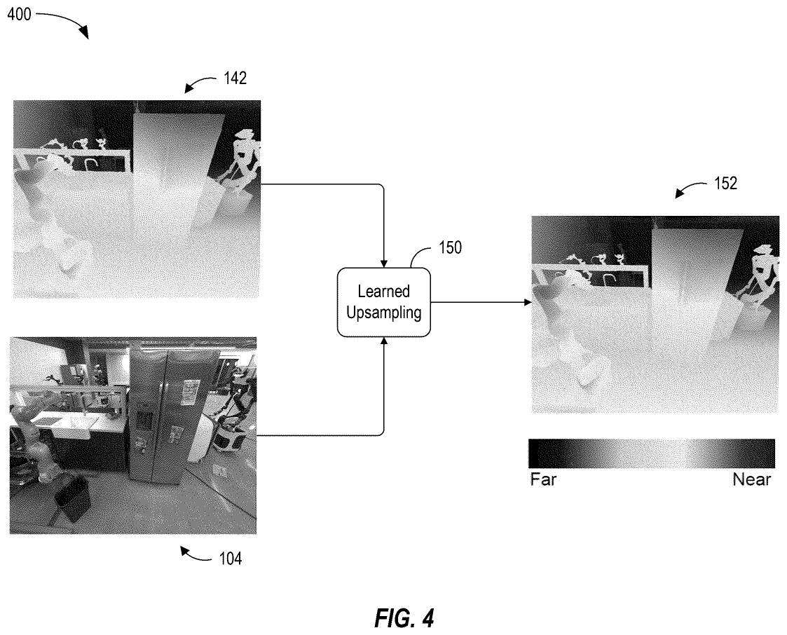

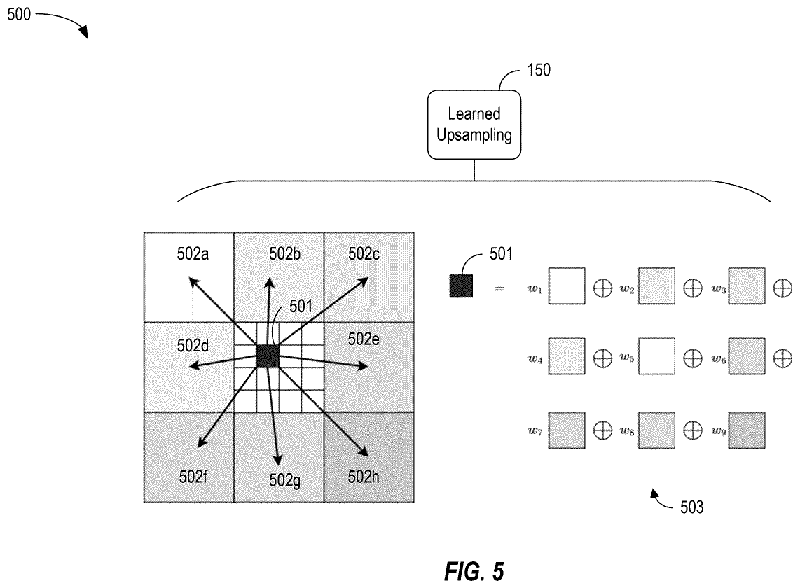

As such, the next stage of the learned stereo architecture 100 includes the learned upsampling block 150, which are discussed with reference to FIGS. 1, 4, and 5. FIG. 4 depicts an illustrative visualization of the inputs to the learned upsampling block 150, for example, which includes the low resolution disparity estimate 142 and one of the input images (e.g., image A 102 or image B 104). FIG. 4 also depicts an illustrative example of the unrefined full resolution disparity estimate 152 generated by the learned upsampling block 150. Additionally, FIG. 5 depicts an example learned upsampling process performed by the learned upsampling block.

The learned upsampling block 150 is an upsampling module configured to implement a convex upsampling method 500. The convex upsampling method 500 is discussed in more detail with respect to FIG. 5. The learned upsampling block 150 includes two convolution layers and a softmax activation to predict the H/N×W/N×(8×8×9) mask for each new pixel 501 in the upsampled optical flow prediction. Each pixel 501 on the unrefined full resolution disparity estimate 152 is a convex combination of previous coarse resolution pixels 502a-h weighted by the predicted mask with {w₁, w₂, . . . , w₉} coefficients 503. The input image (e.g., image A 102 or image B 104) input to the learned upsampling block 150 provides guidance to the convex upsampling method 500 for upsampling the low resolution disparity estimate 142 to the unrefined full resolution disparity estimate 152. This method predicts more accurate optical flow output, particularly near motion boundaries than other methods, for example, such as bilinear upsampling. The output of the learned upsampling block 150 is an unrefined full resolution disparity estimate 152.

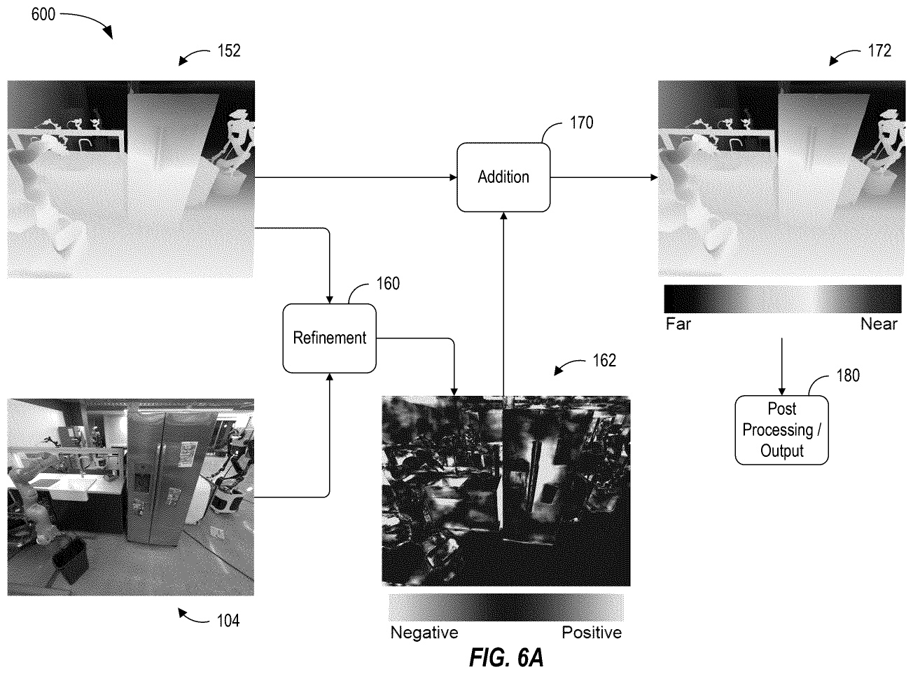

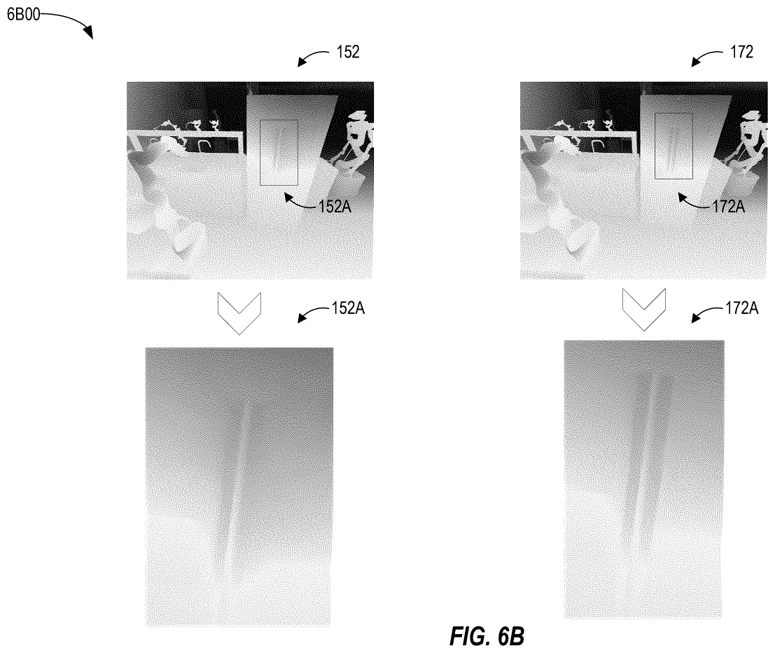

The next stage of the learned stereo architecture 100 includes the refinement block 160 and the addition block 170 which are configured to generate a refined full resolution disparity estimate 162. This stage is discussed in detail with reference to FIGS. 1, 6A and 6B The refinement block 160 receives the unrefined full resolution disparity estimate 152 and the input image (e.g., image A 102 or image B 104) input to learned upsampling block 150 as depicted in FIGS. 1 and 6A.

The refinement block 160 is a network such as a residual neural network (ResNet) configured to estimate where the disparity estimate in the unrefined full resolution disparity estimate 152 is wrong based on one of the original input images (e.g., image A 102 or image B 104). The refinement block 160 generates a disparity residual 162 where each pixel of the disparity residual 162 indicates an error value that is added or subtracted from the disparity values in the unrefined full resolution disparity estimate 152 based on the error the refinement block 160 has determined for each pixel. At the addition block 170, the disparity residual 162 is combined with the unrefined full resolution disparity estimate 152 to generate the refined full resolution disparity estimate 172.

The refinement stage, which includes the refinement block 160 and the addition block 170, is a correction stage that improves the sharpness of the disparity estimate. An illustrative example of the improvement provided by the refinement stage is depicted in FIG. 6B. For example, as depicted in FIG. 6B the left illustration provides the unrefined full resolution disparity estimate 152 and a magnified portion 152A of the unrefined full resolution disparity estimate 152 illustrating the refrigerator door handles. The right illustration provides the refined full resolution disparity estimate 172 and a magnified portion 157A of the refined full resolution disparity estimate 172 illustrating the same refrigerator door handles. As seen in comparing the magnified portions 152A and 172A it is shown that the refined full resolution disparity estimate 172 comprises more defined and sharped edges to for the example feature of the refrigerator door handles. The refinement stage provides an accuracy improvement to the learned stereo architecture 100 output such that it can assure that the disparity estimate generated by the learned stereo architecture 100 is consistent with actual features, structures, edges, textures, and the like that are captured by the input images (e.g., image A 102 and image B 104).

In some embodiments, the learned stereo architecture 100 may further include a post processing/output block 180 as depicted in FIG. 1. The post processing/output block 180 may include one or more processes that converts the disparity values represented in the refined full resolution disparity estimate 172 to depth measurements based on intrinsic and/or extrinsic parameters of the stereo camera system that captured the input images (e.g., image A 102 and image B 104). However, in some embodiments, the output of the learned stereo architecture 100 is the refined full resolution disparity estimate 172.

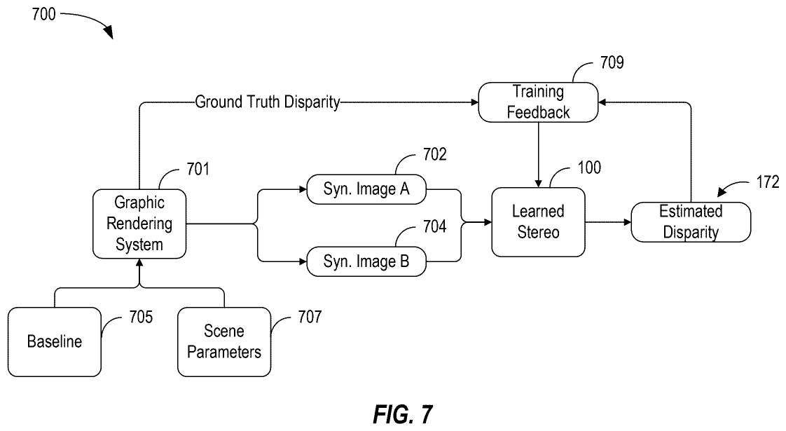

The learned stereo architecture 100 is capable of generating the refined full resolution disparity estimate 172 from the input images (e.g., image A 102 and image B 104) based on a training process that includes generating and feeding fully synthetic labeled data through the model. FIG. 7 depicts an illustrative block diagram 700 of a process for training the learned stereo architecture 100. As noted hereinabove, the learned stereo architecture leverages fully differentiable 3D convolutions instead of a mix of 2D and 3D convolution stages and is trained with fully synthetic labeled data instead of real image data. Training the learned stereo architecture 100 with fully synthetic labeled data (e.g., synthetic image A 702 and synthetic image B 704) provides an exponential increase in the amount and quality of diverse datasets that are also finely labeled at the pixel level since they are generated from graphic rendering systems 701 that can deliver realistic synthetic image data not previously attainable. The fully synthetic labeled data (e.g., synthetic image A 702 and synthetic image B 704) is training data that includes, for example, stereo image pairs corresponding to various baselines 705 and scene parameters 707 (e.g., lighting levels, surfaces, materials, textures, and resolutions, and the like). The fully synthetic labeled data is more than 3 channel data (e.g., red, green, blue data). The fully synthetic labeled data may be more than 3 channel data, for example 16 or 32 channel, where each of the additional channels provide the learned stereo architecture with additional information for training so that when RGB images are fed into the model in an online implementation the learned stereo architecture 100 has developed a diverse set of neural paths and is thus capable of inferences that would not be available from training using sparely pixel labeled RGB real world image pairs.

During training, the estimated disparity 172 that is generated by the learned stereo architecture 100 is compared with ground truth disparity information provided from the graphic rendering system 710 to a training feedback block 709. The training feedback block 709 determines corrections, for example, to weights within the layers of the one or more networks forming the learned stereo architecture 100 to carry out the training of the learned stereo architecture 100. The adjusted weights from the training feedback block 709 are used to update and train the learned stereo architecture 100.

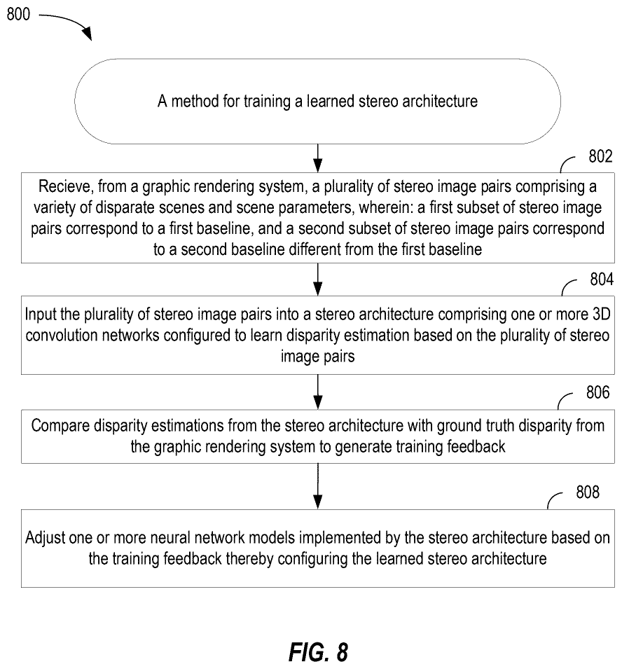

FIG. 8 depicts an example method for training a learned stereo architecture.

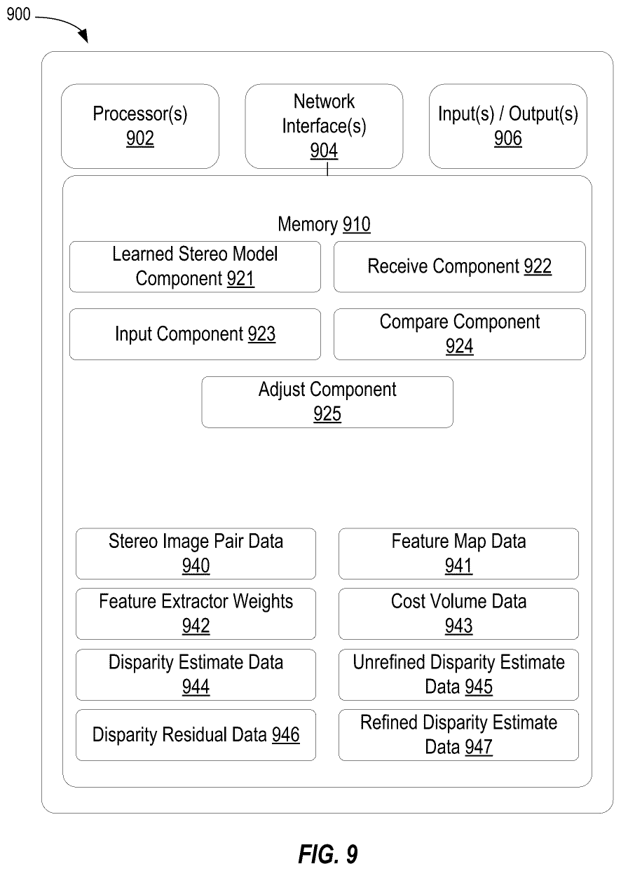

In this example, method 800 begins at step 802 with receiving, from a graphic rendering system, a plurality of stereo image pairs comprising a variety of disparate scenes and scene parameters, wherein: a first subset of stereo image pairs correspond to a first baseline, and a second subset of stereo image pairs correspond to a second baseline different from the first baseline. For example, step 802 may be performed by the apparatus 900 as described herein with reference to FIG. 9 that is configured to perform the processes corresponding to blocks 701, 705, and 707 as described above with reference to FIGS. 7.

Method 800 proceeds to step 804 with inputting the plurality of stereo image pairs into a stereo architecture comprising one or more 3D convolution networks configured to learn disparity estimation based on the plurality of stereo image pairs. For example, step 804 may be performed by the apparatus 900 as described herein with reference to FIG. 9 that is configured to perform the processes corresponding to blocks 702 and 704 as described above with reference to FIG. 7.

Method 800 proceeds to step 806 with comparing disparity estimations from the stereo architecture with ground truth disparity from the graphic rendering system to generate training feedback. For example, step 804 may be performed by the apparatus 900 as described herein with reference to FIG. 9 that is configured to perform the processes corresponding to blocks 100, 172, and 701 as described above with reference to FIG. 7.

Method 800 proceeds to 808 with adjusting one or more neural network models implemented by the stereo architecture based on the training feedback thereby configuring the learned stereo architecture. For example, step 808 may be performed by the apparatus 900 as described herein with reference to FIG. 9 that is configured to perform the process corresponding to block 709 as described above with reference to FIG. 7.

Note that FIG. 8 is just one example of a method, and other methods including fewer, additional, or alternative steps are possible consistent with this disclosure.

FIG. 9 depicts an example apparatus 900 configured to perform the methods described herein.

Apparatus 900 includes one or more processors 902. Generally, processor(s) 902 may be configured to execute computer-executable instructions (e.g., software code) to perform various functions, as described herein.

Apparatus 900 further includes a network interface(s) 904, which generally provides data access to any sort of data network, including personal area networks (PANs), local area networks (LANs), wide area networks (WANs), the Internet, and the like.

Apparatus 900 further includes input(s) and output(s) 906, which generally provide means for providing data to and from apparatus 900, such as via connection to computing device peripherals, including user interface peripherals.

Apparatus 900 further includes a memory 910 configured to store various types of components and data.

In this example, memory 910 includes, a learned stereo model component 921, an receive component 922, an input component 923, a compare component 924, and an adjust component 925.

The learned stereo model component 921 is configured to perform blocks 120, 130, 140, 150, 160, 170, and 180 of the learned stereo architecture 100 depicted and described with reference to FIG. 1.

The receive component 922 is configured to perform blocks 701, 705, and 707 depicted and described with reference to FIG. 7 and step 802 of the method 800 depicted and described with reference to FIG. 8.

The input component 923 is configured to perform blocks 702 and 704 depicted and described with reference to FIG. 7 and step 804 of the method 800 depicted and described with reference to FIG. 8.

The compare component 924 is configured to perform blocks 100, 172, 701, and 709 depicted and described with reference to FIG. 7 and step 806 of the method 800 depicted and described with reference to FIG. 8.

The adjust component 925 is configured to perform block 709 depicted and described with reference to FIG. 7 and step 808 of the method 800 depicted and described with reference to FIG. 8.

In this example, memory 610 also includes stereo image pair data 940, feature map data 941, feature extractor weights 942, cost volume data 943, disparity estimate data 944, unrefined disparity estimate data 945, disparity residual data 946, and refined disparity estimate data 947 as described herein.

Apparatus 900 may be implemented in various ways. For example, apparatus 900 may be implemented within on-site, remote, or cloud-based processing equipment.

Apparatus 900 is just one example, and other configurations are possible. For example, in alternative embodiments, aspects described with respect to apparatus 900 may be omitted, added, or substituted for alternative aspects.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” For example, reference to an element (e.g., “a processor,” “a controller,” “a memory,” etc.), unless otherwise specifically stated, should be understood to refer to one or more elements (e.g., “one or more processors,” “one or more controllers,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. A method for training a learned stereo architecture, the method comprising:
receiving, from a graphic rendering system, a plurality of stereo image pairs comprising a variety of disparate scenes and scene parameters, wherein:
a first subset of stereo image pairs correspond to a first baseline, and
a second subset of stereo image pairs correspond to a second baseline different from the first baseline;
inputting the plurality of stereo image pairs into a stereo architecture comprising one or more 3D convolution networks configured to learn disparity estimation based on the plurality of stereo image pairs;
comparing disparity estimations from the stereo architecture with ground truth disparity from the graphic rendering system to generate training feedback; and
adjusting one or more neural network models implemented by the stereo architecture based on the training feedback thereby configuring the learned stereo architecture.

2. The method of claim 1, wherein the plurality of stereo image pairs utilized to train the stereo architecture are fully synthetic image data.

3. The method of claim 1, wherein the scene parameters comprise at least one of a lighting level, a resolution, a material, a texture, or a surface type.

4. The method of claim 1, wherein the first baseline corresponds to a first stereo image system and the second baseline corresponds to a second stereo image system.

5. The method of claim 1, wherein the one or more 3D convolution networks are configured to learn the disparity estimation at a predetermined resolution less than a resolution of the plurality of stereo image pairs.

6. The method of claim 5, wherein the predetermined resolution is at least one of a factor of 2, 4, or 8 less than the resolution of the plurality of stereo image pairs.

7. The method of claim 1, further comprising implementing the learned stereo architecture with at least one of a robot system or a vehicle system.

8. An apparatus for training a learned stereo architecture, comprising: one or more memories comprising processor-executable instructions; and one or more processors configured to execute the processor-executable instructions and cause the apparatus to:
receive, from a graphic rendering system, a plurality of stereo image pairs comprising a variety of disparate scenes and scene parameters, wherein:
a first subset of stereo image pairs correspond to a first baseline, and
a second subset of stereo image pairs correspond to a second baseline different from the first baseline;
input the plurality of stereo image pairs into a stereo architecture comprising one or more 3D convolution networks configured to learn disparity estimation based on the plurality of stereo image pairs;
compare disparity estimations from the stereo architecture with ground truth disparity from the graphic rendering system to generate training feedback; and
adjust one or more neural network models implemented by the stereo architecture based on the training feedback thereby configuring the learned stereo architecture.

9. The apparatus of claim 8, wherein the plurality of stereo image pairs utilized to train the stereo architecture are fully synthetic image data.

10. The apparatus of claim 8, wherein the scene parameters comprise at least one of a lighting level, a resolution, a material, a texture, or a surface type.

11. The apparatus of claim 8, wherein the first baseline corresponds to a first stereo image system and the second baseline corresponds to a second stereo image system.

12. The apparatus of claim 8, wherein the one or more 3D convolution networks are configured to learn the disparity estimation at a predetermined resolution less than a resolution of the plurality of stereo image pairs.

13. The apparatus of claim 12, wherein the predetermined resolution is at least one of a factor of 2, 4, or 8 less than the resolution of the plurality of stereo image pairs.

14. The apparatus of claim 8, wherein the one or more processors are configured to further cause the apparatus to implement the learned stereo architecture with at least one of a robot system or a vehicle system.

15. A non-transitory computer-readable medium comprising processor-executable instructions that, when executed by one or more processors of an apparatus, causes the apparatus to perform a method comprising:
receiving, from a graphic rendering system, a plurality of stereo image pairs comprising a variety of disparate scenes and scene parameters, wherein:
a first subset of stereo image pairs correspond to a first baseline, and
a second subset of stereo image pairs correspond to a second baseline different from the first baseline;
inputting the plurality of stereo image pairs into a stereo architecture comprising one or more 3D convolution networks configured to learn disparity estimation based on the plurality of stereo image pairs;
comparing disparity estimations from the stereo architecture with ground truth disparity from the graphic rendering system to generate training feedback; and
adjusting one or more neural network models implemented by the stereo architecture based on the training feedback thereby configuring a learned stereo architecture.

16. The non-transitory computer-readable medium of claim 15, wherein the plurality of stereo image pairs utilized to train the stereo architecture are fully synthetic image data.

17. The non-transitory computer-readable medium of claim 15, wherein the scene parameters comprise at least one of a lighting level, a resolution, a material, a texture, or a surface type.

18. The non-transitory computer-readable medium of claim 15, wherein the first baseline corresponds to a first stereo image system and the second baseline corresponds to a second stereo image system.

19. The non-transitory computer-readable medium of claim 15, wherein the one or more 3D convolution networks are configured to learn the disparity estimation at a predetermined resolution less than a resolution of the plurality of stereo image pairs.

20. The non-transitory computer-readable medium of claim 19, wherein the predetermined resolution is at least one of a factor of 2, 4, or 8 less than the resolution of the plurality of stereo image pairs.
